(19) United States
(12) Patent Application Publication
(10) Pub. No.: US 2002/0050071 A1
(43) Pub. Date: May 2, 2002

(54) Dehydration device

(76) Inventor: Tsun-Jen Lin, Taipei (TW)

Correspondence Address: Mr. Peter F. Corless, EDWARDS & ANGELL, LLP, 101 Federal Street, Boston, MA, 02110, US

(21) Appl. No.: 09/999,013

(22) Filed: Oct. 31, 2001

(30) Foreign Application Priority Data
Nov. 1, 2000 (TW) TW 89218979

(51) Int. Cl. F26B 19/00

(52) U.S. Cl. 34/60

(57) ABSTRACT

A dehydration device is proposed, in which a tub body is formed with a receiving space for receiving a bag containing substances e.g. water-containing garbage to be dehydrated. In operation, after placing the bag in the receiving space, a base board of the tub body can be driven by a driving mechanism to move downwardly so as to squeeze the bag in a manner that, a plurality of sharp portions formed on the base board can pierce bottom of the bag, allowing air and liquid to flow out from the bag to achieve the dehydration purpose. After completing dehydration, residue of the dehydrated substances together the bag are removed from the dehydration device; this makes the dehydration conveniently cleaned after use. The substance residues can then be easily separated from the bag simply by shaking the pierced bag to tear it apart. This therefore facilitates the implementation of garbage sorting.

### FIELD OF THE INVENTION

The present invention relates to dehydration devices, and more particularly, to a dehydration device used for draining water out of water-containing substances.

### BACKGROUND OF THE INVENTION

With increasing environmental awareness and decreasing areas of usable land, the reduction of garbage dumping becomes one of the most important aspects in the current treatment of waste disposal. If garbage created in daily life is sorted effectively, and the sorted garbage is recycled and treated beforehand, this can significantly reduce the amount of garbage to be incinerated or buried in the end as compared to that of unsorted garbage. Therefore, garbage sorting is a primary step to be promoted for desirably achieving the reduction of garbage. Nevertheless, among the sorted garbage, kitchen garbage takes up 30-40% of the total garbage. Since kitchen garbage is high in water content, it is not suitably subjected to general garbage incineration or burial treatment. In the case of incineration treatment, a large amount of carbon dioxide is generated from water combustion under high temperature, and exhausts into the atmosphere through chimneys. This therefore can be a main cause of greenhouse effect. In the case of burial treatment, environmental pollution may occur due to leakage of polluted liquid that is not effectively purified from the buried kitchen garbage. However, liquid purification is cost-ineffective to implement, thereby possibly making funds relatively reduced for treatment of other waste or garbage. Therefore, how to effectively solve the problem of kitchen garbage in a substantial amount of total garbage, has become a major topic to be investigated in the field of environmental protection.

Besides, prior to treatment of kitchen garbage e.g. incineration, burial or recycling, the first important thing is to drain liquid out of the kitchen garbage by means of squeezing, so as to reduce its volume and weight for easy transportation. This can save energy consumed for incineration, delay garbage decomposition, and decrease pollution. Also, the drained liquid from kitchen garbage is actually cleaner than liquid from decomposed garbage, and thus extent of pollution is reduced.

It has been realized that kitchen garbage can be recycled to become compost; however, this method is not widely used due to problems of hygiene and storage, especially in heavily populated urban regions. Although there are drainage devices for draining liquid from kitchen garbage to be subjected to recycling, incineration or burial, such devices are disadvantageous in the inconvenient treatment of garbage residues after liquid drainage; this is therefore a critical problem to solve.

### SUMMARY OF THE INVENTION

A primary objective of the present invention is to provide a dehydration device, which can effectively drain water out of water-containing substances, and allow residues of the substances after dehydration to be easily separated from a bag structure used to contain the substances for conducting water drainage, so as to eliminate environmental pollution problems.

In order to achieve the above and other objectives, a dehydration device proposed in the present invention comprises: a tub body having a base board and a receiving space confined by the tub body, wherein the base board is provided with a plurality of through holes connected to the receiving space, and a plurality of sharp portions protrude from an inner surface of the base board facing the receiving space and radially arrange outwardly from a center of the base board, allowing each of the sharp portions to correspond to one of the through holes; a pressing board upwardly and downwardly movable in the receiving space of the tub body; a driving mechanism connected to the pressing board for moving the pressing board upwardly and downwardly in the receiving space of the tub body; and a supporting stand for fixing the tub body and the driving mechanism.

The driving mechanism can be driven manually or by using a motor to move the pressing boarding to move upwardly and downwardly, and is structurally designed as general mechanical transmission assembly without any specific limitation. Moreover, in operation, first, the driving mechanism may move the pressing board downwardly to a certain position for squeezing water-containing substances for liquid drainage. After liquid is sufficiently drained out, the pressing board can be moved to an even lower position, allowing the substances to be further pressed to drain out more liquid. This operating procedure can be performed until the substances are satisfactorily dehydrated. Besides, a guiding member can be installed below the base board, allowing the liquid to flow directly into a drainage hole of a sink through the connection between the guiding member and the drainage hole of the sink.

In order to release air in a tied-up bag structure containing substances to be dehydrated after the bag structure is placed in the receiving space of the tub body and squeezed by the pressing board, the sharp portion at the center of the base board is higher than the other sharp portions around the center, and is formed with a plurality of holes. When the bag structure is placed into the receiving space, it can be firstly pierced by the central sharp portion on the base board due to the weight of the bag structure, so as to form a passage for releasing air from the bag structure. After the bag structure is further squeezed by the pressing board, it is pierced by the other sharp portions on the base board. Also, the central sharp portion higher in dimension can reach the substances contained in the bag structure, allowing liquid in the substances to be more quickly drained through the holes on the central sharp portion.

### BRIEF DESCRIPTION OF THE DRAWINGS

The present invention may best be understood through the following description with reference to the accompanying drawings, in which:

FIG. 1 is a partial sectional view of a dehydration device of the invention;

FIG. 2 is a perspective view of a dehydration device of the invention;

FIG. 3 is a schematic diagram showing a dehydration device of the invention accommodating a bag structure for conducting dehydration.

### DETAILED DESCRIPTION OF THE PREFERRED EMBODIMENT

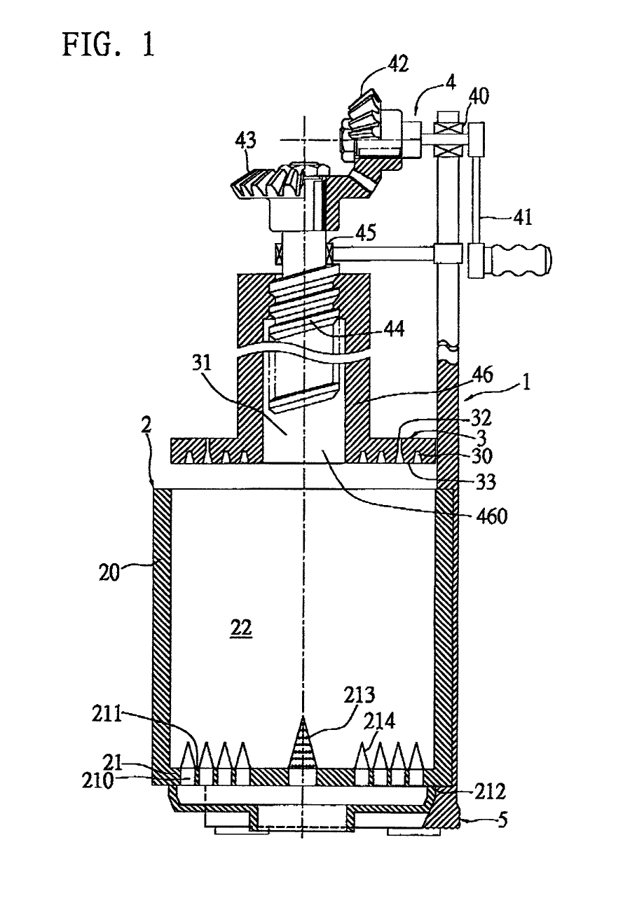

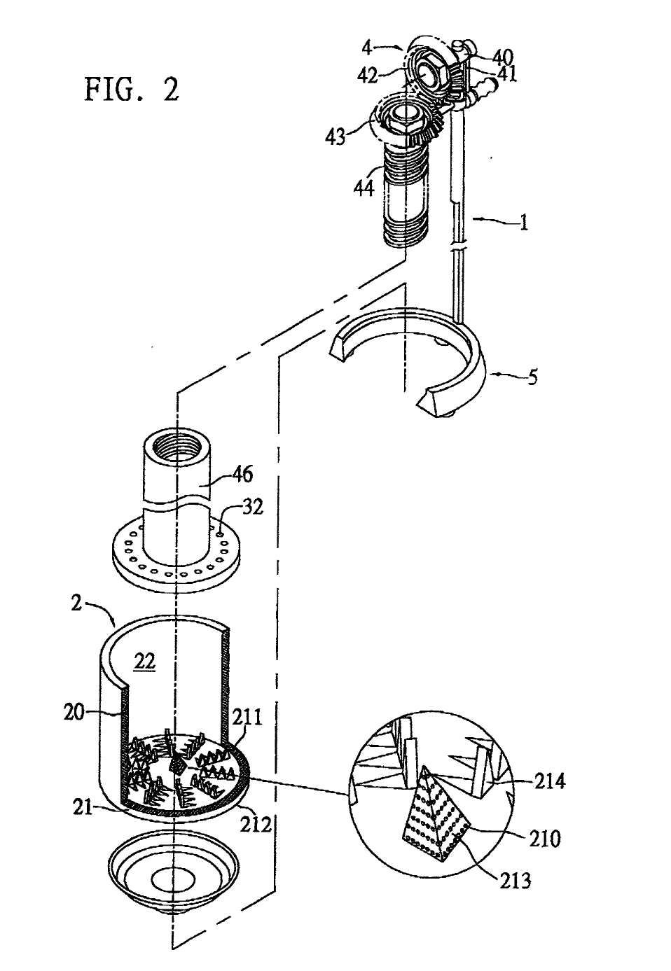

As shown in FIGS. 1 and 2, a dehydration device 1 of the invention comprises: a tub body 2, a pressing board 3 received in the tub body 2, a driving mechanism 4 connected to the pressing board 3, and a supporting stand 5 for fixing the tub body 2 and the driving mechanism 4.

The tub body 2 has an annular tub wall 20 and a base board 21 covering one end of the tub wall 20, and a receiving space 22 is formed by the base board 21 and inner walls of the annular tub wall 20. Moreover, the base board 21 is provided with a plurality of through holes 210 connected to the receiving space 22. The base board 21 has an inner surface 211 facing the receiving space 22, and an outer surface 212. On the inner surface 211 there protrude a high sharp portion 213 at a central position and a plurality of low sharp portions 214 that are radially arranged outwardly with respect to the high sharp portion 213 as the center, wherein each of the high sharp portion 213 and the low sharp portions 214 corresponds to one of the through holes 210. It should be understood that, there is no limitation in the heights of the high sharp portion 213 and the low sharp portions 214 that protrude above the inner surface 211; however, the high sharp portion 213 tends to have a larger base area than the lower sharp portions 214. This therefore makes a hole on a bag structure pierced by the high sharp portion 213 larger than holes pierced by the lower sharp portions 214. And, the pierced hole made by the high sharp portion 213 becomes a central point for tearing the bag structure apart by the weight of residues of substances contained in the bag structure after dehydration. The high sharp portion 213 is also formed with a plurality of holes, allowing liquid from substances contained in the bag structure to flow out through the holes on the high sharp portion 213 when the high sharp portion 213 penetrates the bag structure; this therefore accelerates drainage of the liquid from the substances.

The pressing board 3 is basically dimensioned in surface area to be equal to cross section area of the receiving space 22. After the pressing board 3 is placed into the receiving space 22 of the tub body 2, the receiving space 22 is generally sealed by the pressing board 3. The pressing board 3 can be provided with a plurality of holes 30 for allowing air or liquid to pass therethrough, wherein at a central position thereof there is formed a through hole 31 corresponding to the high sharp portion 213 on the base board 21 that can therefore protrude out of the pressing board 3 through the through hole 31. Similarly, when the pressing board 3 is driven by the driving mechanism 4 to move towards the base board 21 until reaching the low sharp portions 214, in order to prevent the low sharp portions 214 from being damaged by the pressing board 3, a plurality of concentrically-arranged recessed holes 32 are formed on a bottom 33 surface of the pressing board 3, for receiving the corresponding low sharp portions 214.

The driving mechanism 4 consists of a rotating handle 41 connected to the supporting stand 5 through a first bearing member 40; an active gear wheel 42 axially connected to the rotating handle 40; a passive gear wheel 43 vertically engaged with the active gear wheel 42 and driven by the same; a shaft pole 44 axially connected to the passive gear wheel 43 and perpendicular to the pressing board 21; a second bearing member 45 for fixing the shaft pole 44 and connected at one end thereof to the supporting stand 5; and a driving pole 46 having one end thereof screwingly coupled to the shaft pole 44, and the other end axially connected to the pressing board 3. The driving pole 46 is a hollow pole body, with its hollow portion 460 connected to the through hole 31 of the pressing board 3, allowing the high sharp portion 213 to protrude through a top surface 32 of the pressing board 3 to enter the hollow portion 460 without being damaged.

The driving mechanism 4 is operated by a user clockwise rotating the rotating handle 41 manually, so as to activate the active gear wheel 42 for anti-clockwise turning the passive gear wheel 43, which makes the shaft pole 44 anti-clockwise rotated. This in turn leads the driving pole 46 to move downwardly, and then makes the pressing board 3 perpendicularly connected to the driving pole 46 to move towards the base board 21. On the contrary, in order to separate the pressing board 21 from the tub body 2 for placing an object in the receiving space 22 of the tub body 2, it only needs to anti-clockwise rotate the rotating handle 41, so as to make the driving pole 46 together with the shaft pole 44 move upwardly; this can therefore move the pressing board 3 upwardly until it is separated from the tub body 2.

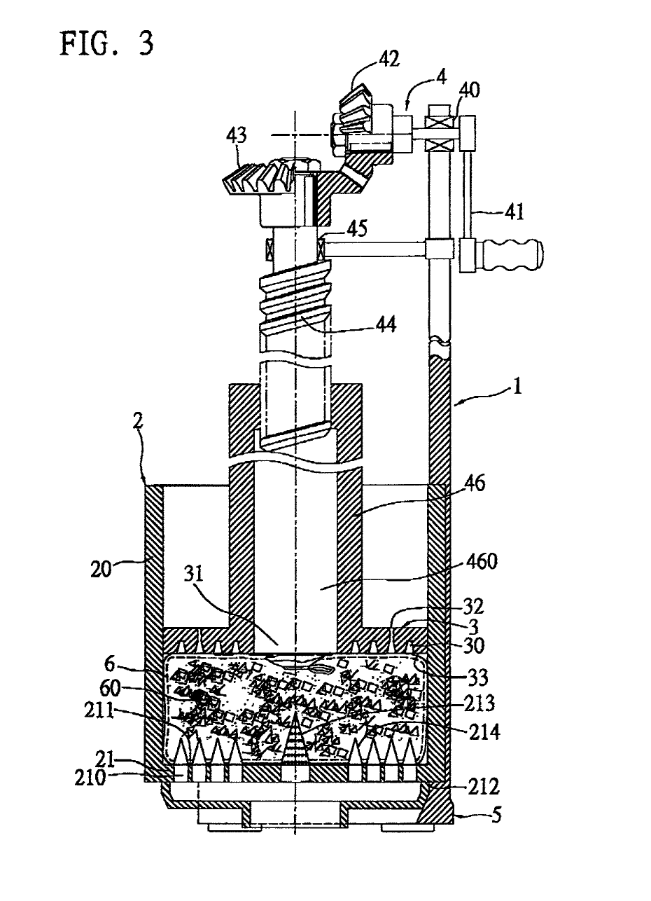

When in use, as shown in FIG. 3, the dehydration device 1 of the invention is placed above a drainage hole of a washing sink (not shown). Then, as described above, the pressing board 3 is moved upwardly to a position (not shown) separated from the tub body 2, and a plastic bag 6 loaded with water-containing substances 60 (kitchen garbage or materials for dehydration) is placed in the receiving space 22 of the tub body 2, with an opening of the bag 6 being tied up. Due to the weight of the water-containing substances 60, before the plastic bag 6 completely drops onto the base board 21, a portion of the plastic bag 6 facing the base board 21 can be pierced by at least the high sharp portion 213, so that air or liquid stored in the plastic bag 6 can flow out first. After the plastic bag 6 completely drops on the base board 21, it can be further pierced by the low sharp portions 214 on the base board 21, thereby resulting in a plurality of pierced holes radially and outwardly arranged on the plastic bag 6. When the driving mechanism 4 is operated to allow the driving pole 46 to move the pressing board 3 downwardly along an axial direction of the tub body 2 for squeezing the plastic bag 6, liquid drained by squeezing the water-containing substances 60 in the plastic bag 6 can flow out through the pierced holes made by the high sharp portion 213 and the low sharp portions 214, and then through the through holes 210 of the base board 21 out of the tub body 2 to be drained through the drainage hole of the washing sink. In order to allow the drained liquid from the water-containing substances 60 to collectively flow through the drainage hole of the washing sink, a funnel-shaped guiding cup 7 can be provided beneath the base board 21, with a bottom-end opening of the guiding cup 7 being connected to the drainage hole of the washing sink.

After the liquid of the water-containing substances 60 in the plastic bag 6 is sufficiently drained out, the pressing board 3 can be raised by means of the driving mechanism 4 until it is separated from the tub body 2, allowing the plastic bag 6 to be retrieved from the receiving space 22. Since the plastic bag 6 has its bottom surface formed with the plurality of holes, residues of the drained substances 60 can be separated from the plastic bag 6 simply by holding the tied-up end of the plastic bag 6 and shaking it downwardly. This makes the plastic bag 6 tom apart at positions of the holes due to the weight of the substance residues, and the purpose of separating the drained substances 60 and the plastic bag 6 can be easily achieved.

In the use of the dehydration device of the invention, during a dehydration process, water-containing substances are wrapped in a bag structure (made of plastic or a material easy to be pierced). Therefore, after completing dehydration, residues of the substances are not scattered around in a tub body of the dehydration device. This brings much convenience for cleaning the dehydration device after use. At the same time, the bag structure and the substance residues can be easily separated; this facilitates the implementation of garbage sorting.

The invention has been described using exemplary preferred embodiments. However, it is to be understood that the scope of the invention is not limited to the disclosed embodiments. On the contrary, it is intended to cover various modifications and similar arrangements. The scope of the claims, therefore, should be accorded the broadest interpretation so as to encompass all such modifications and similar arrangements.

What is claimed is:

1. A dehydration device, comprising:
a tub body having a base board and a receiving space confined by the tub body, wherein the base board is formed with a plurality of through holes connected to the receiving space, and a plurality of sharp portions protrude from a surface of the base board facing the receiving space and radially arrange outwardly from a center of the base board;
a pressing board upwardly and downwardly movable in the receiving space of the tub body;
a driving mechanism connected to the pressing board for moving the pressing board upwardly and downwardly in the receiving space of the tub body; and
a supporting stand for fixing the tub body and the driving mechanism, and cooperated with at least one coupling member placed into a drainage hole for stabilizing the device in operation.

2. The dehydration device of claim 1, wherein the sharp portion formed at the center of the base board is higher than the other sharp portions formed around the center of the base board.

3. The dehydration device of claim 2, wherein the sharp portion formed at the center of the base board is larger in dimension than the other sharp portions, so that a hole pierced by the sharp portion at the center of the base board is larger than holes made by the other sharp portions.

4. The dehydration device of claim 1, wherein the driving mechanism is driven manually.

5. The dehydration device of claim 1, wherein the driving mechanism is driven by using a motor.

6. The dehydration device of claim 1, wherein the pressing board is formed with a plurality of holes thereon.

7. The dehydration device of claim 6, wherein each of the holes on the pressing board corresponds to one of the sharp portions formed on the base board.

8. The dehydration device of claim 1, wherein the pressing board is formed with a through hole at a central position thereof, allowing the sharp portion at the center of the base board to protrude through the through hole.

9. The dehydration device of claim 1, wherein the coupling member is coupled to bottom of the tub body and placed into the drainage hole of a washing sink for stabilizing the device in operation.
